(19) United States
(12) Patent Application Publication
(10) Pub. No.: US 2002/0024630 A1
(43) Pub. Date: Feb. 28, 2002

(54) SAFETY GLASSES WITH LOW-PROFILE PRESCRIPTION EYEGLASS MOUNT

(76) Inventor: WOLFGANG HORNIG, BAMMENTAL DEUTSCHLAND (DE)

Correspondence Address: JOHN D. TITUS, GALLAGHER & KENNEDY, P.A., 2575 EAST CAMELBACK ROAD, PHOENIX, AZ, 85016-9225, US

(21) Appl. No.: 09/230,681

(22) PCT Filed: Jul. 31, 1997
(86) PCT No.: PCT/DE97/01622

(30) Foreign Application Priority Data
Aug. 2, 1996 (DE) 296 13 426.0

(51) Int. Cl. G02C 1/00

(52) U.S. Cl. 351/41; 351/65; 351/69; 351/78

(57) ABSTRACT

The invention concerns protective goggles comprising a frame which is open at the bottom, two side pieces, and a transparent interchangeable shield which has a nose recess, partially engages in the frame and is supported thereby. The nose recess has at least one clamping groove into which fits a nose section which is adapted to the shape of the nose recess and has a peripheral groove and two retaining pins. A lens support lies adjacent the nose section and has openings through which the retaining pins pass. Provided on each side of the nose recess is a lens which fits closely on the lens support. In addition, a resilient nose protector lies adjacent the lens and is connected to the nose section.

The present invention relates to safety glasses consisting of a frame that is open at the bottom, and has two temples, and a transparent, replaceable shield that is supported by the frame, incorporates a nose cutout, as defined in the preamble to Patent claim 1, in particular for use by health practitioners such as physicians, dentists, dental technicians, laboratory technicians, chemists, athletes, and all individuals who need to protect their eyes.

Safety glasses of this kind are described in German utility patent G 88 00 762. These safety glasses offer not only protection against eyes infections caused by pathogenic agents, but also against injuries that could be caused when work pieces such as dentures are being ground; because of their particular construction they are readily adaptable to various head shapes, and they have a light-weight, protective shield that is simple to replace.

In particular, the portion of the frame that is essentially horizontal incorporates two sliding cross pieces that are of an essentially U-shaped section, the two arms of which overlap the upper area of the shield in such a way that said shield is clamped in position on the inside, in the area of the sliding cross pieces.

These safety glasses are suitable mainly for use by individuals who do not wear eyeglasses. If they are to be used by eyeglass wearers, problems are encountered, in particular, with the temples that are required for the optical eyeglasses and with the temples that are required for the safety glasses.

It is the objective of the present invention to create safety glasses that can be worn without any problems by individuals who wear eyeglasses, and which also minimize the possibility of injuries in the area of the base of the nose, i.e., to the ethmoid bone.

Proceeding from safety glasses of the kind described in greater detail in the introduction hereto, this problem has been solved by the features set out in the descriptive part of claim 1; advantageous configurations are described in the secondary claims.

The safety glasses according to the present invention also offer the advantages of the known safety glasses with respect to protecting the eyes against infection or mechanical injuries, and at the same time they permit the problem-free integration of the eyeglasses, hereinafter referred to as the lenses, so that they are suitable for all eyeglass wearers, given appropriate adaptation of the lenses

The present invention will be described in greater detail below on the basis of an advantageous embodiment shown in the drawings appended hereto. These drawings show the following:

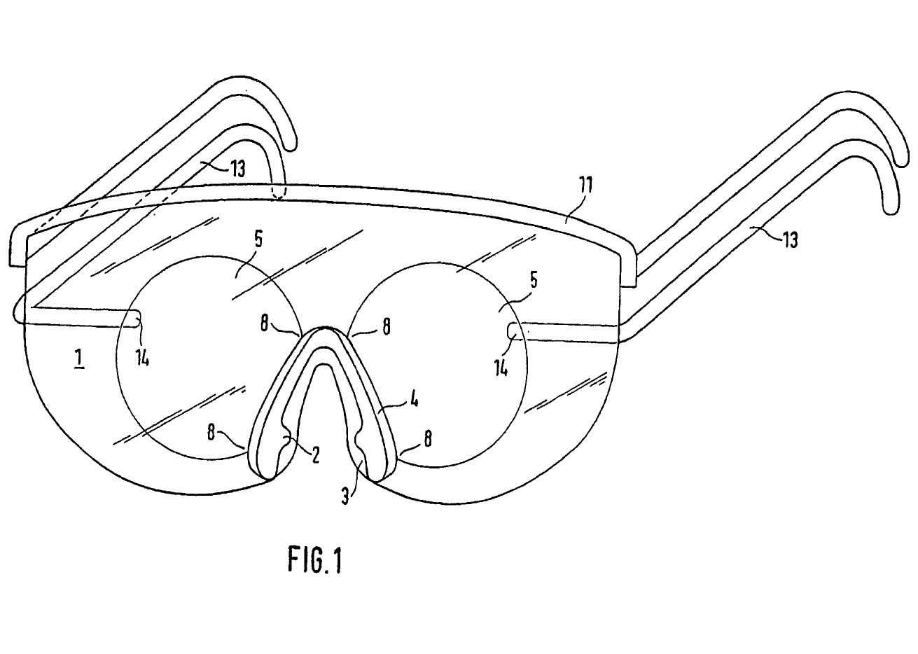

FIG. 1: A perspective view of the safety glasses according to the present invention;

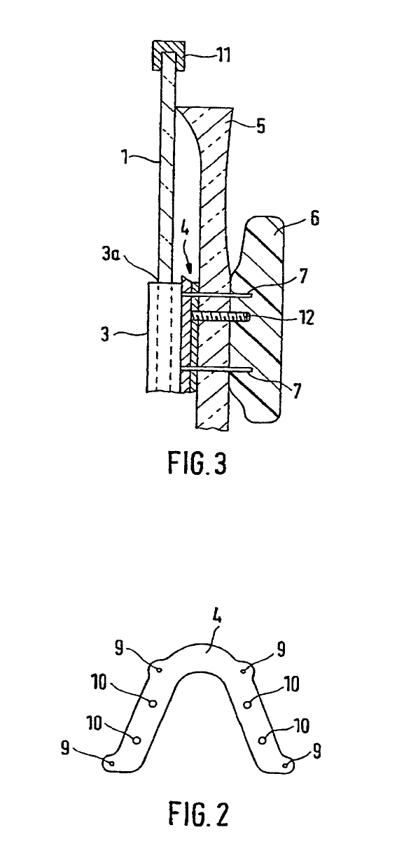

FIG. 2: A plan view of the lens carrier;

FIG. 3: A cross section on the vertical axis of symmetry through the nose cutout of the safety glasses.

FIG. 1 shows the safety glasses with a shield 1 that fits partially in an essentially U-shaped groove (not shown herein) in frame 11, by which it is supported. The design of the frame, temples, and shield 1 corresponds essentially to that described in the German Utility Patent 88 00 762 referred to in the introduction hereto, i.e., in that the shield 1 is supported in the frame 11 so as to be removable therefrom, although without the cross pieces described therein.

The shield 1 incorporates a nose cutout that, in the embodiment shown, is provided with two clamping grooves 2 into which fits a bail-shaped nose section 3; this nose section 3 incorporates a peripheral groove 3a. The nose section that is, for example, of plastic, is provided with at least two retaining pins 7 that are horizontal when the safety glasses are being worn, and extend during use towards the wearer's head. These retaining pins pass through a thin, spring-hard lens support 4 that is of metal or plastic, is similarly bail-shaped, and is shown in plan view in FIG. 2. Once installed, this lens carrier is immediately adjacent to the nose section 3.

The lens carrier 4 is joined to the lenses 5 that are arranged on both sides of the nose cutout and correspond to the conventional prescription eyeglass lenses. This connection can be effected by way of screws 12 (as in FIG. 3) that are fixed rigidly to the lens carrier 4 and pass through corresponding openings in the lens 5. The lens carrier 4 can also be joined to each individual prescription lens 5 by cementing, or by a clamped fit or rivets, or by press fasteners. Once the lenses 5 have been attached to the lens carrier 4, a flexible nose protector 6 that is of soft rubber or of soft plastic, and which reduces the pressure exerted by the safety glasses on the nose, is installed on the lens carrier. It is also possible to cement the lens carrier directly to the protective shield and/or the lenses.

FIG. 3 shows a cross section on the axis of symmetry through the nose cutout of the safety glasses shown in FIG. 1. This drawing shows the conventional shield 1 in the frame 11, the nose section with the peripheral middle groove 3a being clamped in the nose cutout. This nose section 3 is provided with the retaining pins 7 that pass through the lens carrier 4 and, optionally, through the lenses 5. In FIG. 3, one of the screws that extend from the lens carrier 4, through the lens 5, and as far as the nose protector 6, is numbered 12.

The lens carrier 4, for example in the form of a 0.2 mm thick, extremely spring-hard small metal plate, is press fitted onto the retaining pin 7 that is arranged in the nose section 3. Next, the lens, previously prepared by using a template, is installed on the appropriate screw 12 and fastened thereon. Finally, in order to cover the assembly, the nose protector 6 is installed, so that the nose unit with the integrated optics is formed; this makes it possible to clean both optical components, i.e., the lenses and the shield, separately and then reassemble them once again in a simple manner, without having to use any special holding devices. A further advantage is that the lenses 5 are pressed against the shield 1 of the safety glasses by a specific amount of pressure.

Finally, the lens carrier can be provided with two temples 13 that are joined to it, for example, by being clamped, if the lens carrier 4 with the lenses 5 is used without the shield 1.

1. Safety glasses, in particular for physicians, dentists and dental technicians, for athletes of all kinds, and for all individuals who need to protect their eyes, these consisting of a frame 11 that is open at the bottom, two temples, a transparent, removable shield that incorporates a nose cutout, and a nose protector 6, the shield fitting partially in the frame and being supported by this, characterized in that the nose cutout is provided with at least one clamping groove 2 in which fits a nose section 3 that is adapted to the shape of the nose cutout, this nose section 3 incorporating a peripheral groove 3a; in that the nose section is provided with at least two retaining pins 7, that extend in the direction of the head of the eyeglass wearer; in that a lens carrier 4 that incorporates openings 10 through which the retaining pins pass is adjacent to the nose section; in that there is a lens 5 on each side of the nose cutout, each lens being adjacent to the lens carrier; and in that a flexible nose protector is adjacent to the lenses and is joined to the nose section.

2. Safety glasses as defined in claim 1, characterized in that the lens carrier is provided with screws 12; and in that each lens incorporates at least one opening to accommodate these screws.

3. Safety glasses as defined in one of the preceding claims, characterized in that the lens carrier 10 is also provided with openings to accommodate the retaining pins 7.

4. Safety glasses as defined in one of the preceding claims, 1, characterized in that the flexible nose protector 6 is a flexible element that is of rubber or soft plastic and reduces the contact pressure exerted by the safety glasses.

5. Safety glasses as defined in one of the preceding claims, characterized in that the lens carrier is provided with two removable temples.

6. Safety glasses as defined in claim 1, characterized in that the lenses 5 are joined to the lens carrier 4 by press fasteners.

7. Safety glasses as defined in one of the foregoing claims, characterized in that the lens carrier is of spring-hard material that is essentially 0.2 mm thick.

8. Safety glasses as defined in one of the foregoing claims, characterized in that the lens carrier 4 is of spring-hard plastic.
